(19) United States
(12) Patent Application Publication
(10) Pub. No.: US 2013/0334720 A1
(43) Pub. Date: Dec. 19, 2013

(54) TWO-COMPONENT THERMOSET-RUBBER OBJECT

(71) Applicant: Rik Gielen, Overpelt (BE)

(72) Inventor: Rik Gielen, Overpelt (BE)

(21) Appl. No.: 14/001,881

(22) PCT Filed: Feb. 27, 2012
(86) PCT No.: PCT/IB12/50890

§ 371 Date: Aug. 28, 2013

(30) Foreign Application Priority Data
Feb. 28, 2011 (BE) 2011/0138

(51) Int. Cl. B29C 65/00

(52) U.S. Cl. CPC B29C 66/90
USPC 264/40.1; 264/250

(57) ABSTRACT

A shaped object is including a rigid and a resilient part, wherein the rigid part includes a thermoset and provides support to the resilient part. The resilient part includes vulcanized rubber. The object is manufactured according to a method of a pre-forming step wherein the thermosetting composition is pre-formed in a first mould and subsequently cured at a temperature in the range of 150 to 230 C to form the rigid part, after which the first mould is adjusted and/or the cured rigid part is transferred to a second mould, and subsequently the rubber is shaped and vulcanized, while the rubber is in contact with the thermoset of the rigid part, at a temperature in the range of 150 to 230 C to form the resilient part.

### FIELD OF THE INVENTION

The present invention relates to objects which have to provide sufficient mechanical strength but also need to provide at some of their surfaces shock-absorbing or sealing properties and/or need to fulfil a closing function. More in particular, the invention relates to machine or construction parts, from for example pneumatic or hydraulic systems, wherein elastic seals are provided between the rigid parts to separate the contents of the entity, or the state thereof, from the environment of the entity.

### BACKGROUND OF THE INVENTION

From many parts proper mechanical properties are expected, but it is also expected that they also close or seal off properly at certain contact surfaces with other parts, for example, to keep the contents of the systems under pressure and/or avoid leakage of the contents to the environment. Such components may be found for example in hydraulic or pneumatic systems, in the chemical process technology, in vehicles, but also in more common home, garden, and kitchen utensils or appliances such as washing machines, vacuum cleaners, blenders and food processors.

Those parts are, due to the mechanical requirements, often made out of metal. For the sealing a separate rubber part is then usually provided, which is then provided between the surfaces with which two components come into contact with each other. To hold the rubber parts in place, recesses are quite often provided in the contact surfaces. The rubber components may for the same reason possibly also be glued to one of the contact surfaces.

This assembly technique implies that at the time of the assembly an additional component, in this case the rubber component, has to be provided. This additional component should for a correct fitting be located exactly at the prescribed position. Such additional components increase the complexity and degree of difficulty of the assembly, as well as the risk for problems and/or failures. Additional components require their own supply chains, may be lost or missing, and may possibly be assembled wrongly. In each of these cases this leads to problems at the assembly stage itself or jeopardizes the proper functioning of the whole.

To get around this problem, objects have been designed whereby a rubber component is integrated with a rigid part in the same object. For example, JP 02103110 A describes how an amount of a rubber composition is first injected by injection moulding through a first nozzle into the cavity of a mould with movable core and before the curing of the rubber, a thermosetting resin is injected through a second nozzle into the remaining free space in the mould, while pressing the core in a different position, after which the thermosetting resin is cured and the rubber is vulcanized at the same time. This method gives according to JP 02103110 A a very firm connection between the two materials of the shaped object, which makes the object suitable for oil seals in the engines of motorcycles. Also JP 63264322 A, JP 59202928 A and JP57084834 A describe similar objects manufactured by the insertion of a thermosetting resin and a rubber composition to be vulcanized into a casting or pressing mould, after which the resin is cured and the rubber is vulcanized at the same time. The problem with these two-component objects thus manufactured is that this method of production cannot ensure precise dimensions for the two parts, because deformation of the free surface of the firstly introduced component may occur during the introduction of the second component. The intermediate surface between the two parts, therefore, is not exactly defined. Because of the different mechanical properties of the two parts, this leads to problems. For example, the distortion characteristics of an elastic part are not exactly predictable, because the dimensions thereof are not exactly defined.

JP 2007-011047 describes how by centrifugal casting (“spin casting” or “centrifugal moulding”), a two-piece rubber sheet is formed. In a first step the mould is partially, yet at least 80%, filled with a first polyurethane composition for a more elastic rubber with an a-value of 0.85, which is then cured at 130° C. Subsequently in a second step, the mould is filled with a second polyurethane composition for a rubber having a higher hardness and lower surface friction, and cured. The final product is a rubber knife of 2 mm thick with the elasticity of the first rubber, but with on one side, due to the harder rubber layer of about 0.1 mm, the low frictional resistance of the second rubber, and which is due to this combination of properties very suitable as a scraping knife (“cleaning blade”) in the electrophotography or dry photocopying technique. JP 2007-011047 states that the thickness of the surface layer is of minor importance, as long as it is present, and no thicker than 20% of the total sheet thickness, and this to be able to maintain the elasticity of the main layer. Also in this technique the dimensions of the two components in their tangential plane are not exactly guaranteed.

WO 2008/003279 discloses a component for a vacuum pump consisting of a thermoset part and a silicone rubber part in contact with the thermoset part. The parts are formed by injection moulding in successive steps. The process comprises a first step in which the thermosetting composition is poured into a mould, after which the mould is adapted to receive the injection of silicone rubber. Between two consecutive injection moulding steps a process step may be provided in which the temperature of the thermoset part is adjusted, and also a deburring process step may be inserted. WO 2008/003279 does not describe the conditions under which the curing of the silicone rubber must take place. It is known to the person skilled in the art that silicone rubber is very often vulcanized at room temperature, which is generally known as “Room-temperature vulcanizing” (RTV). During cooling of the thermoset part down to room temperature, before the rubber composition is injected, there is a risk that due to thermal shrinkage a clearance is created between the thermoset part and the mould in which it sits. As a result, upon the injection of the rubber composition, some of the composition may leak into the space formed by the clearance, and vulcanize therein. Because of this, the rubber part is deformed, it deviates from the intended dimensions, and the thermoset part is marred with spots or a rubber layer on those surfaces where the rubber has no function. This means, moreover, an additional consumption of raw material.

Due to the lack of exactly guaranteed dimensions of the contact surface between the two components forming the objects from the prior art, there remains a need for a method which confers a higher precision to the dimensions of the various parts in the manufacture of objects which consist of a rigid thermoset part and an integrated elastic rubber part.

The present invention aims to avoid or at least alleviate the problems described above and/or in general, to provide improvements.

### SUMMARY OF THE INVENTION

According to the invention there is provided a multi-part shaped object as well as a process for the manufacture thereof, as defined in any of the attached claims.

The invention provides a shaped object, comprising a rigid part and a resilient part, wherein the rigid part comprises a thermoset and provides mechanical support to the resilient part, the resilient part comprising vulcanized rubber and being suitable for fulfilling a sealing and/or shock-absorbing function, characterized in that the object is manufactured according to a method comprising a pre-forming step wherein the thermosetting composition is pre-formed in a first mould and then cured to form the rigid part, wherein the curing of the thermoset is carried out at a temperature in the range of 150 to 230° C., after which the first mould is adjusted and/or the cured rigid part is transferred to a second mould, and wherein the rubber is shaped afterwards by injection moulding, transfer moulding, press moulding, and/or pressing, and subsequently vulcanized to form the resilient part, and this while the rubber is in contact with the thermoset of the rigid part, wherein the vulcanization is carried out at a temperature in the range of 150 to 230° C.

We have found that in this way the dimensions of the two parts of the object may be guaranteed very precisely, also those of the intermediate surface which is created between the two or more different parts or components of the multi-part object. This advantage is provided because the first thermoset material is cured while it is still in its first mould, which guarantees very precise dimensions for the first part. The shaping of the rubber part occurs then subsequently in a space of which the dimensions are also precisely known, which is formed by the second and/or modified mould and the cured rigid part with its exact dimensions, so that the vulcanized rubber part also obtains exactly guaranteed dimensions. This offers the advantage that the behaviour of the rubber part may be very accurately predicted, which in many applications is of great importance such as the provision of a good seal under well-determined stress conditions. By allowing both the curing of the thermoset and the vulcanization of the rubber to take place in the temperature range 150-230° C., any possible shrinkage of the cured rigid part relative to the mould remains minimal, because the cured rigid part fills up the first mould as good as possible, so that possible leakage of the rubber composition between the mould and the cured rigid part is kept as small as possible, or even avoided. Under these conditions, it is also possible to assure that both the rigid part and the rubber part obtain exactly guaranteed dimensions. In this way, is also avoided that more rubber composition would be used than is necessary for the resilient part to be shaped, or that the object would have to be subjected to a post-treatment to remove the rubber caused by leakage. Such additional steps are usually complex and time consuming, and do generally not succeed in restoring the desired view of a pristine thermoset surface.

In another embodiment, the invention provides a method for manufacturing a shaped object, characterized in that the method comprises a pre-forming step wherein the thermosetting composition is preformed in a first mould, and is subsequently at least partially cured to form the rigid part, after which the first mould is adjusted and/or the cured rigid part is transferred to a second mould, and wherein the rubber is shaped by injection moulding, transfer moulding, press moulding, and/or pressing, and subsequently vulcanized to form the resilient part, and this while the rubber is in contact with the thermoset of the rigid part, wherein the curing of the thermoset is carried out at a temperature in the range of 150 to 230° C. and wherein the vulcanization is carried out at a temperature in the range of from 150 to 230° C.

### DETAILED DESCRIPTION

The cured thermoset which forms the rigid part of the object of the present invention, preferably has at least one feature, and possibly all of the features, from the list consisting of

a Rockwell hardness as measured according to the standard test method ASTM D-785 with a Rockwell tester, of at least M60 to M140, preferably at least M70, more preferably at least M75 or even more preferably at least M80, and optionally at most M130, preferably at most M125, and more preferably at most M120,

a Brinell hardness HB measured according to ISO 6506-1:2005 as HBS 10/100 of at least 1.6, preferably of at least 2.6, more preferably a HBW 10/3000 of at least 15, preferably at least 35, yet more preferably of at least 70, more preferably at least 90, yet more preferably at least 110, preferably at least 120, and further preferably at least 140, preferably at least 150, more preferably at least 200, even more preferably at least 250, preferably at least above 300, more preferably at least 350, more preferably at least 500, and more preferably at least 800,

a tensile strength, as measured on a sample made by injection moulding in accordance with ISO 527, preferably from 10 to 400, more preferably from 20 to 300, yet more preferably from 30 to 200, even more preferably from 40 to 100, still more preferably from 60.0 to 70.0 MPa,

an elongation at break, as measured on a sample made by injection moulding in accordance with ISO 527, of not more than 1.000%, preferably not more than 0.900%, more preferably not more than 0.800%, more preferably at most 0700%, and even further more preferably not more than 0.600%,

an E-modulus, or Young's Modulus of elasticity at room temperature (at about 23° C., or in other assays in the range of 20-25° C.) as measured according to the standard test method ASTM D-638 of at least 2 to 30 GPa, preferably at least 3 and more preferably at least 4 or even 5 GPa, yet more preferably at least 6, or 7, or even 8 GPa, thereby possibly not more than 25 GPa, preferably not more than 20 GPa, but above that preferably not more than 18 GPa, or even not more than 16.0 GPa,

a flexural modulus as measured on a sample made by injection moulding in accordance with ISO 178, of not more than 30 GPa, preferably not more than 25 GPa, more preferably not more than 20 GPa, moreover, preferably not more than 19 or even 18 GPa, and possibly at least 10 GPa, preferably at least 14 GPa, more preferably at least 16.0 GPa,

a notch impact value determined by the Charpy impact strength test of at 23° C., as measured on a non-notched specimen, made by injection moulding in accordance with ISO 179/1 eU, preferably from about 0.50-12.00 J/cm2, more preferably from 0.70-9.00 J/cm2, more preferably from 0.90-7.00 J/cm2, more preferably of from 1.00-4.00 J/cm2,

a notch impact value determined by the Charpy impact strength test of at 23° C., as measured on a notched test sample, made by injection moulding in accordance with ISO 179/1 eA, preferably from 0.100 to 1.000 J/cm2, more preferably from 0.200 to 0.700 J/cm2, more preferably from 0.300 to 0.500 J/cm2, more preferably from 0.350 to 0.450 J/cm2,

an Electrical Volumetric Resistivity, as measured according to standard IEC 60093, preferably from 1.00 e+6 to 1.00 e+16 ohm-cm, more preferably 1.00 e+9 to 1.00 e+16 ohm-cm, more preferably 1.00 e+12 to 1.00 e+16 ohm-cm, more preferably from 1.00 e+15 to 1.00 e+16 ohm-cm,

a dielectric constant as measured at a frequency of approximately 100 Hz in accordance with standard IEC 60250, preferably from 1.50 to 10.00, more preferably from 3.00 to 8.00, more preferably from 4.00 to 7.00, more preferably from 6.00 to 6.50.

The vulcanized rubber which forms the elastic or resilient part of the object according to the present invention preferably has at least one feature, and possibly all of the features, from the list consisting of

a glass transition temperature Tg of not more than 25° C., preferably at most 15° C., more preferably at most 0° C., further preferably at most −10° C., preferably at most −25° C., yet more preferably at most −40° C., even more further preferably at most −50° C., more preferably −60° C., and yet more preferably at most −70° C.,

an E-modulus, or Young's Modulus of elasticity at room temperature (about 23° C., or in the range of 20-25° C.) as measured according to the standard test method ASTM D-412, of preferably from 5×10⁻⁴ to 5 GPa, more preferably from 5×10⁻³ to 1 GPa, more preferably from 1×10⁻² to 0.5 GPa,

a tensile strength at room temperature (about 23° C., or in the range of 20-25° C.) as measured according to the standard test method ASTM D-412 of from 7 to 20 MPa, preferably from 12 to 17 MPa.

Preferably, the thermoset in the object according to the present invention is selected from the list consisting of a phenol resin or a phenol formaldehyde (PF) resin, in which optionally substituted phenols such as cresol and/or other aldehydes than formaldehyde have been incorporated, and wherein novolac resin, or Bakelite but preferably resole resin is selected, a melamine formaldehyde (MPF) resin, a cellulose resin, a bis-maleimide resin, an epoxy resin, preferably based on bisphenol A, a polyester resin, a polyimide resin, a polyurethane resin, a silicone resin, urea, or urea-formaldehyde resin, melamine or melamine-formaldehyde resin, and mixtures thereof, where appropriate supplemented with a hardener, such as an epoxy resin, in which case the hardener may be an amine or an acid anhydride.

Found particularly suitable as thermosets are epoxy EP 3535, Melopas MP 180/181/182/183, Ralupol UP 804/4385/4806, all from the company Raschig, and Vyncolit 2923W Black, 4523XB Black, 4421XB Black, X613 Black, Green, X655/X620/X680 black, green from the company Vyncolit.

In one embodiment of the present invention, the thermoset part is preferably reinforced with fibers, preferably fibers selected from the list consisting of glass fibre (GF), carbon fibre, cellulose fibre, and mixtures thereof. The fibres bring the advantage that the brittleness of the rigid part is reduced, and its strength is increased. This is particularly the case with phenol resins, which are preferably reinforced with glass fibres and/or mineral fibres.

In one embodiment of the object according to the present invention, the rigid part further comprises at least one element selected from the list consisting of a filler, an organic peroxide, a mould release agent, and a curing promoter, wherein the filler is preferably selected from the list consisting of graphite, graphite powder, wood powder, wood flour, talcum powder, sand, a silicate, clay, and other mineral fillers such as calcium carbonate, and mixtures thereof.

In another embodiment of the object according to the present invention, the rubber is selected from the list consisting of natural rubber, polyisoprene, preferably for at least 50% consisting of cis-polyisoprene, styrene-butadiene rubber, butadiene rubber, ethylene propylene rubber, nitrile rubber, chloroprene rubber, butyl rubber, silicone rubber, polynorbornene rubber, poly-urethane rubber, fluorocarbon rubber, polyacrylate rubber, fluorosilicone rubber, epichlorohydrine rubber, chlorosulfonated rubber, hydrated nitrile rubber, and mixtures thereof.

The most common way to, vulcanize rubber, applicable to the majority of diene rubbers, such as natural rubber, styrene-butadiene rubber, ethylene propylene rubber and nitril rubber, is vulcanization with sulphur, in which the rubber is heated with sulphur, usually in the presence of organic vulcanization accelerators to save both time and raw materials. Diene rubbers may also be vulcanized with sulphur chloride or with a thiuram disulfide or bismorfoline disulfide. Butyl rubber may be vulcanized with quinonedioxim or phenols. Vulcanization with peroxides may be applied almost universally and is primarily used with ethylene propylene rubber and silicone rubber. Chloroprene rubber does not vulcanize with sulphur but does so with zinc oxide or a thiourea. Acrylate rubbers which contain a halogenated co-monomer are vulcanized with polyamines, and fluororubbers with a mixture of a metal oxide and an amine.

In yet another embodiment of the object according to the present invention, the rubber is vulcanized with sulphur or with peroxides.

In the embodiment according to the present invention wherein the rubber is vulcanized with sulphur, the rubber contains at most 35% by weight of sulphur, preferably at most 25%, more preferably at most 15%, yet more preferably at most 10%, more preferably at most 8% or even only 6% by weight, and optionally the rubber contains at least 0.5% by weight of sulphur, preferably 1% by weight, and more preferably 1.2% by weight, calculated on the basis of the weight of rubber present in the resilient part.

In an embodiment of the object according to the present invention, the resilient part further comprises in addition to the rubber at least one element selected from a vulcanization accelerator, a catalyst, a filler, wherein preferably the filler is selected from the list already given above.

In another embodiment, the object according to the present invention is selected from the list consisting of a pump housing, a pump casing, a cylinder head cover for an internal combustion engine, an oil sump, a brake cylinder, an electrical component, such as a pedestal for an electrical relay, preferably a watertight relay, components for general electrical applications with water-tight requirements, such as for a pond pump or a submerged water pump, a part of a hydraulic and/or pneumatic application, such as a valve casing or housing, etc . . . .

The inventors have further found that with some thermosetting resins, a certain degree of thermal shrinkage may occur upon cooling after the curing of the thermoset. Particularly with such thermosets, it is preferred by the inventors that the rigid part is still sufficiently warm when the rubber composition is introduced into the cavity provided by the second mould or by the modified first mould.

In the method according to the present invention, the cured rigid part has, in an embodiment wherein the curing of the thermoset is carried out at a temperature in the range of 150 to 230° C. and wherein the vulcanization is carried out at a temperature in the range of from 150 to 230° C., at the onset of the vulcanization a temperature not lower than at most 50 degrees Celsius under the vulcanization temperature of the rubber, more preferably not lower than at most 30 degrees Celsius, more preferably at most 25 degrees Celsius, and further preferably at most 20 degrees Celsius, more preferably at most 15 degrees Celsius, and more preferably at most 10 degrees Celsius below, more preferably not lower than at most 5° C. below, more preferably not less than at most 2 degrees Celsius below, and most preferably not lower than the vulcanization temperature of the rubber.

This offers the advantage that the rigid part still well, or tightly, fills the part of the modified or second mould which is intended for it, at the moment the rubber composition is inserted, in such a way that no or virtually no amount of the rubber composition may slip between the mould and the rigid part where it is not intended to flow to, even with thermoset materials which are characterized by a degree of thermal shrinkage.

In a further embodiment according to the present invention, the vulcanization is carried out at a temperature not lower than a maximum of 50 degrees Celsius under the curing temperature of the thermoset, more preferably not lower than at most 30 degrees Celsius, more preferably at most 25 degrees Celsius, and yet more preferably at most 20 degrees Celsius, more preferably that most 15 degrees Celsius, and more preferably at most 10 degrees Celsius below, more preferably at most 5° C. below, more preferably not less than at most 2 degrees Celsius below, and most preferably not lower than the curing temperature of the thermoset.

This offers the advantage that the rigid part still well, or tightly, fills the part of the modified or second mould, which is being intended for it, at the moment that the rubber composition is introduced, in such a way that no or virtually no amount of the rubber composition may slip between the mould and the rigid part where it is not intended to flow to, even with thermoset materials which are characterized by a degree of thermal shrinkage.

In an embodiment of the method according to the present invention, the rubber is provided in the modified or second mould in a composition which further comprises at least one element selected from sulphur, a sulphur-containing component, a vulcanization accelerator, a catalyst, a filler, wherein preferably the filler is selected from the list that have already been given earlier in this document.

In a further embodiment of the method according to the present invention, the vulcanization is carried out at a temperature in the range of from 160 to 210° C., preferably from 170 to 200° C., and more preferably from 175 to 195° C.

In yet a further embodiment of the method according to the present invention, the curing of the thermoset is carried out at a temperature in the range of 155 to 210° C., preferably from 160 to 200° C., and more preferably of 165 to 195° C.

In another embodiment of the method according to the present invention, the temperature of the rigid part is modified by heating or by cooling before it is brought into contact with the rubber composition. This reduces the risk that the rubber composition would vulcanize prematurely, before it would have filled the space in the mould. This additional step is preferably used if a thermoset is chosen which is characterized by little or no thermal shrinkage, or, if the second mould is adapted to closely enclose the rigid part at the appropriate temperature at those points or surfaces which are not intended to come into contact with the rubber composition.

In a further embodiment of the method according to the present invention, the curing and/or the vulcanization is progressed further by an additional thermal treatment by exposure of the object to a particular temperature, such as described herein above for a period of at least 4 hours, preferably at least 8 hours, more preferably 12 hours, further preferred at least 18 hours, preferably at least 24 hours, more preferably 36 hours, more preferably at least 48 hours, or even at least 72 hours.

In a further embodiment of the method according to the present invention, the method further comprises the deburring of at least one side of at least a part of the object, selected from the rigid part and the resilient part, or of both parts.

In a further embodiment of the method according to the present invention, the method includes subjecting the object to a mechanical operation selected from the list consisting of drilling, milling, turning on a lathe, and tapping screw thread, or a combination thereof.

In a further embodiment of the method according to the present invention, the method further comprises subjecting the object to a surface treatment selected from the list consisting of labelling, lacquering, painting, printing, metallization, such as vapour deposition of a metal, and rough sanding, for example to give at least one of the surfaces a rougher aspect, or a combination thereof.

In a further embodiment of the method according to the present invention, the method further comprises the introduction into the object of an insert, such as a bolt or other metal part, for example, an electrical contact, and this insertion may occur even before the thermosetting composition is introduced into the first mould, or before or after the vulcanization of the rubber, and which may also occur before or after the deburring, or before or after the mechanical treatment, or before or after the surface treatment.

In yet a further embodiment of the method according to the present invention, the method further comprises the incorporation of the object into a composite object.

Now this invention has been fully described, the skilled person will realize that the invention may be carried out with a wide range of parameters within what is claimed, without thereby departing from the spirit and scope of the invention. As is understood by the skilled in the art, the general invention as defined by the claims comprises other preferred embodiments, which are not specifically mentioned.

1-21. (canceled)

22. A method for producing a shaped object, comprising a rigid and a resilient part, wherein the rigid part comprises a thermoset and provides mechanical support to the resilient part, the resilient part comprising vulcanized rubber, and being suitable for performing a sealing and/or shock-absorbing function, characterized in that the method comprises a pre-forming step wherein the thermosetting composition is pre-formed in a first mould and then cured to form the rigid part, wherein the curing of the thermosetting composition is carried out at a temperature in the range of 150 to 230° C., after which at least one step follows selected from adjusting the first mould and transferring the cured rigid part to a second mould, and wherein the rubber is shaped afterwards by a treatment selected from injection moulding, transfer moulding, press moulding, pressing, and combinations thereof, and wherein the rubber is subsequently vulcanized to form the resilient part, and this while the rubber is in contact with the thermoset of the rigid part, wherein the vulcanization is carried out at a temperature in the range of 150 to 230° C.

23. The method according to claim 22, wherein the cured thermoset has at least one feature from the list consisting of
a Rockwell hardness as measured according to the standard test method ASTM D-785 with a Rockwell tester, of at least M60 to M140,
a Brinell hardness HB measured according to ISO 6506-1:2005 as HBS 10/100 of at least 1.6,
a tensile strength, as measured on a sample made by injection moulding in accordance with ISO 527, from 10 to 400 MPa,
an elongation at break, as measured on a sample made by injection moulding in accordance with ISO 527 of not mote than 1.000%,
an E-modulus, or Young's Modulus of elasticity at room temperature, as measured according to the standard test method ASTM D-638 of at least 2 to 30 GPa,
a flexural modulus, as measured on a sample made by injection moulding in accordance with ISO 178, of not more than 30 GPa,
a notch impact value, determined by the Charpy impact strength test of at 23° C., as measured on a non-notched specimen, made by injection moulding in accordance with ISO 179/1 eU, from about 0.50-12.00 J/cm2,
a notch impact value, determined by the Charpy impact strength test of at 23° C., as measured on a notched test sample, made by injection moulding in accordance with ISO 179/1 eA, from 0.100 to 1,000 J/cm2,
an Electrical Volumetric Resistivity, as measured according to standard IEC 60093, from 1.00 e+6 to 1,00 e+16 ohm-cm,
a dielectric constant, as measured at a frequency of approximately 100 Hz in accordance with standard IEC 60250, from 1.50 to 10.00.

24. The method according to claim 22, in which the vulcanized rubber has at least one feature from the list consisting of
a glass transition temperature Tg of not more than 25° C.,
an E-modulus, or Young's Modulus of elasticity, at room temperature, as measured according to the standard test method ASTM D-412, of from 5×10⁴ to 5 GPa,
a tensile strength at room temperature, as measured according to the standard test method ASTM D-412 of from 7 to 20 MPa.

25. The method according to claim 22, wherein the thermoset is selected from the list consisting of a phenol resin, a phenol formaldehyde (PF) resin, a melamine formaldehyde (MPF) resin, a cellulose resin, a bis-maleimide resin, an epoxy resin, a polyester resin, a polyimide resin, a polyurethane resin, a silicone resin, an urea resin, an urea-formaldehyde resin, a melamine resin, a melamine-formaldehyde resin, and mixtures thereof, where appropriate supplemented with a hardener.

26. The method according to claim 22, wherein the thermoset is reinforced with fibres.

27. The method according to claim 22, wherein the rigid part further comprises at least one element selected from the list consisting of a filler, an organic peroxide, a mould release agent, and a curing promoter, also called a catalyst.

28. The method according to claim 27, wherein the filler in the rigid part is selected from the list consisting of graphite, graphite powder, wood powder, wood flour, talcum powder, sand, a silicate, clay, and other mineral fillers such as calcium carbonate, and mixtures thereof.

29. The method according to claim 22, wherein the rubber is selected from the list consisting of natural rubber, polyisoprene, styrene-butadiene rubber, butadiene rubber, ethylene propylene rubber, nitrile rubber, chloroprene rubber, butyl rubber, silicone rubber, polynorbornene rubber, poly-urethane rubber, fluorocarbon rubber, polyacrylate rubber, fluorosilicone rubber, epichlorohydrine rubber, chlorosulfonated rubber, hydrated nitrile rubber, and mixtures thereof.

30. The method according to claim 22, wherein the rubber is vulcanised with an agent selected from sulphur and peroxides.

31. The method according to claim 30, wherein the rubber is vulcanised with sulphur, and wherein the rubber contains at most 35% by weight of sulphur, calculated on the basis of the weight of rubber present in the resilient part.

32. The method according to claim 22, wherein the resilient part in addition to the rubber further comprises at least one element selected from a vulcanization accelerator, a catalyst, and a filler.

33. The method according to claim 32, wherein the filler in the resilient part is selected from the list consisting of graphite, graphite powder, wood powder, wood flour, talcum powder, sand, a silicate, clay, and other mineral fillers such as calcium carbonate, and mixtures thereof.

34. The method according to claim 22, wherein the object is selected from the list consisting of a pump housing, a pump casing, a cylinder head cover for an internal combustion engine, an oil sump, a brake cylinder, an electrical component, such as a pedestal for an electrical relay, components for general electrical applications with water-tight requirements, such as a submerged water pump, a part of a hydraulic and/or pneumatic application, such as a valve housing.

35. The method according to claim 22, wherein the vulcanization is carried out while the cured rigid part has a temperature not lower than at most 50 degrees Celsius under the vulcanization temperature of the rubber.

36. The method according to claim 22, wherein the vulcanization is carried out at a temperature in the range of from 160 to 210° C.

37. The method according to claim 22, wherein the curing of the thermoset is carried out at a temperature in the range 155 to 210° C.

38. The method according to claim 22, wherein at least one step selected from the curing and the vulcanization is progressed further by providing an additional thermal treatment by exposure of the object o the temperature specified for that step, for a period of at least 4 hours.

39. The method according to claim 22, further comprising the deburring of at least one side of at least a part of the object, the part being selected from the rigid part and the resilient part, and a combination of both parts.

40. The method according to claim 22, further comprising subjecting the object to a mechanical operation selected from the list consisting of drilling, milling, turning on a lathe, and tapping screw thread, and a combination thereof.

41. The method according to claim 22, further comprising subjecting the object to a surface treatment selected from the list consisting of labelling, lacquering, painting, printing, metallization, such as vapour deposition of a metal, and rough sanding, for example to give at least one of the surfaces a rougher aspect, and a combination thereof.

42. The method according to claim 22, further comprising the introduction into the object of an insert, such as a bolt or other metal part.

43. The method according to claim 22, further comprising the incorporation of the object into a composite object.
